(19) United States
(12) Patent Application Publication
(10) Pub. No.: US 2004/0173982 A1
(43) Pub. Date: Sep. 9, 2004

(54) All-terrain board with leg operated brake

(76) Inventor: Graeme Scott Attey, South Fremantle (AU)

Correspondence Address: DUANE MORRIS LLP, P. O. BOX 1003, 305 NORTH FRONT STREET, 5TH FLOOR, HARRISBURG, PA, 17108-1003, US

(21) Appl. No.: 10/799,120

(22) Filed: Mar. 11, 2004

Related U.S. Application Data
(62) Division of application No. 10/333,294, filed on Jan. 16, 2003.

(30) Foreign Application Priority Data
Jul. 18, 2000 (AU) PQ8837

(51) Int. Cl. B62M 1/00

(52) U.S. Cl. 280/87.041

(57) ABSTRACT

An all-terrain board (10, 50) ridden by a rider (18) standing on the board (10, 50) is provided with a braking member which can be engaged by a leg of the rider (18) and moved into braking engagement with a wheel (14, 52). The braking engagement may be directly onto a tyre (15) of the wheel (14). Alternatively, the braking engagement may be indirectly onto a wheel (52) through a linkage connecting the brake (60) to a brake mechanism (74) acting on a rim (56) of the wheel (52).

The present invention relates to an all-terrain board.

### FIELD OF THE INVENTION

The present invention is applicable in general to all-terrain boards arranged to be ridden by a rider standing on a board member such as skate boards, mountain boards, grass boards and similar devices which may have two, three or four wheels.

Braking systems for all-terrain boards have been described previously such as in International Patent Application No. PCT/AU98/01007.

However, there is a need for a braking system for all-terrain boards which enables braking to be effected in a way which is safe, convenient, effective, reliable and predictable.

The present invention provides an all-terrain board having a braking system which, at least in part, provides safe, convenient, effective, reliable and predictable braking under a range of conditions.

### SUMMARY OF THE INVENTION

In accordance with one aspect of the present invention there is provided an all-terrain board arranged to be ridden by a rider standing on a board member, which comprises a wheel means and a brake means having a braking member arranged to be engaged by a leg of a rider so as to apply braking force to the wheel means of the board.

In one embodiment of the present invention, the braking member may be arranged to act directly on a wheel of the board. In particular, the braking member may be arranged to act on a tyre of the wheel to impart braking force to the wheel.

In another embodiment of the present invention the braking member may act indirectly on a wheel of the board. In particular, the braking member may be arranged to cause a braking device to act on a rim of the wheel to impart braking force to the wheel

### BRIEF DESCRIPTION OF THE DRAWINGS

The present invention will now be described, by way of example, with reference to the accompanying drawings, in which:

FIG. 1 is a side elevation of an all-terrain board in accordance with a first embodiment of the present invention;

FIG. 2 is a view similar to FIG. 1 showing a brake means being applied by a rider;

FIG. 3 is a view of a rear portion of the all-terrain board of FIG. 1 to an enlarged scale;

FIG. 4 is a view similar to FIG. 3 showing a brake means being applied;

FIG. 5 is a side elevation of part of a rear portion of an all-terrain vehicle according to a second embodiment of the present invention showing a brake means;

FIG. 6 is a side elevation similar to FIG. 5 showing the brake means being applied to a wheel rim;

FIG. 7 is a plan view of the second embodiment of FIG. 5; and

FIG. 8 is a plan view similar to FIG. 7 showing the brake means being applied to a wheel rim.

### DESCRIPTION OF THE INVENTION

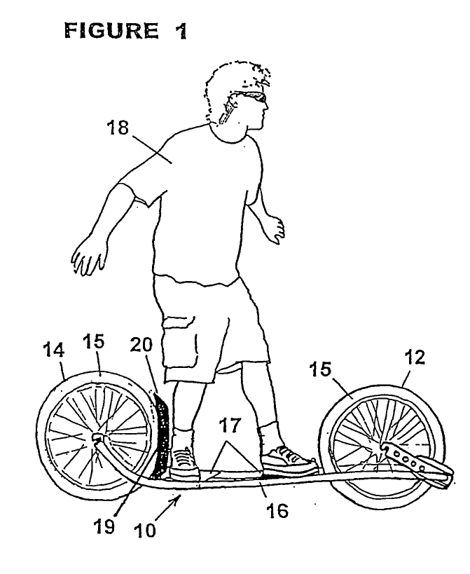

In FIGS. 1 to 4 of the accompanying drawings, there is shown an all-terrain board 10 including a leading wheel 12, a rear wheel 14 and a frame 16 interconnecting the wheels 12 and 14. Each wheel 12 and 14 is provided with a tyre 15. Further, a board member 17 is mounted on the frame 16 between the wheels 12 and 14. The board 10 is provided with a brake means 19.

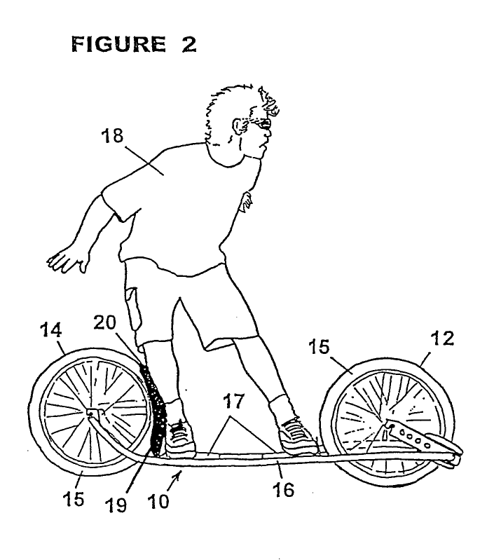

As shown in FIGS. 1 and 2 the all-terrain vehicle 10 is arranged to be ridden by a rider 18 standing on the board member 17.

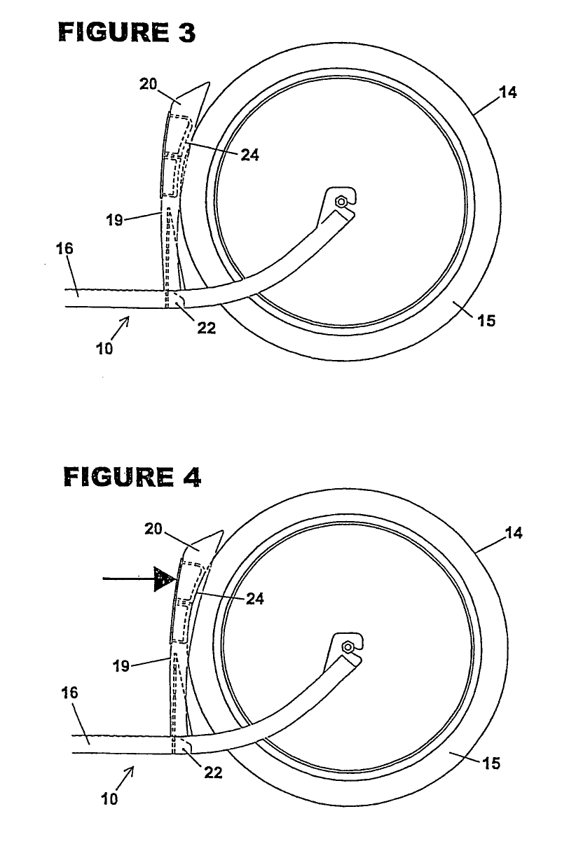

As can best be seen in FIGS. 3 and 4 an upright braking member 20 of the brake means 19 extends upwardly from the frame 16. The braking member 20 is connected to the frame 16 of the board 10 about a transverse pivotal mounting 22 (see FIGS. 3 and 4). Further, the braking member 20 has a concave shape facing the tyre 15 of the rear wheel 14. Preferably, internally of the concave shape the brake member 20 is provided with a brake contact surface 24 which is formed of material having suitable wear and friction properties to withstand the pressure and temperature of braking against the tyre. Preferably, spring means (not shown) is provided to return the braking member 20 to the non-engaged position shown in FIG. 3 when no force is applied to the braking member

In use, the rider 18 rides the all-terrain board 10 in the manner shown in FIG. 1. However, if the rider 18 decides to reduce the speed of the all-terrain board 10 when in motion he simply has to lean backward as shown in FIG. 2. This prevents a rider 18 from being thrown forward when braking and is a natural, safe stance for a rider to maintain when an all-terrain board is slowing down. However, as can be seen in FIG. 2, the arrangement of the present invention enables the rider 18 to apply pressure to the braking member 20 by means of the calf of his rearwardly disposed leg. This causes the braking member 20 to contact the tyre 15 of the rear wheel 14 by means of the brake contact surface 24. As a result a braking force is applied to the rear wheel 14 and the all-terrain board 10 is caused to slow down. The braking member 20 may be made of steel, aluminium, plastics material or composite material whilst the braking contact surface 24 may be formed of rubber, metal, composite material or suitable plastics material able to withstand the heat, pressure and friction created by braking against the tyre 15. In this regard, relatively low coefficient of friction plastic materials have been found to offer suitable performance for low cost.

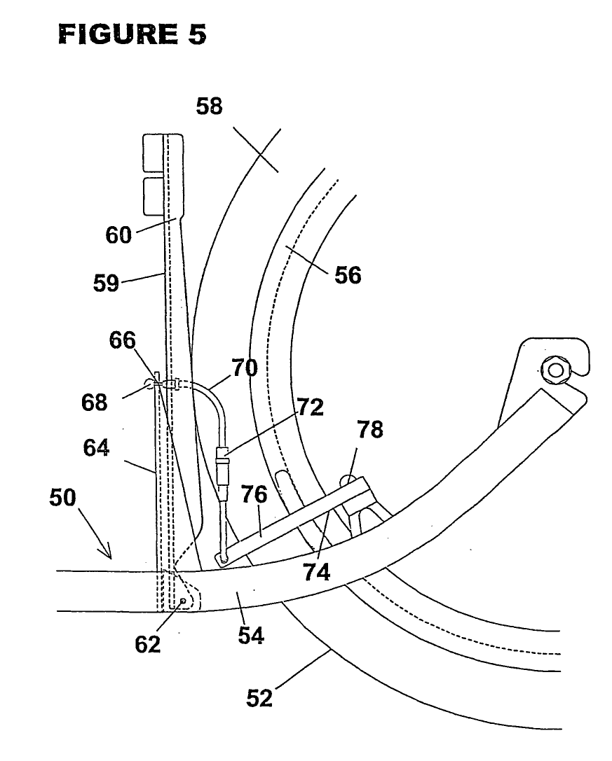

In FIGS. 5 to 8 there is shown a portion of a rear part of an all-terrain vehicle 50 which is similar to that shown in FIGS. 1 to 4.

The vehicle 50 has a rear wheel 52 mounted on a frame 54. The wheel 52 has a rim 56 having a tyre 58 extending thereabout. The vehicle 50 is provided with a brake means

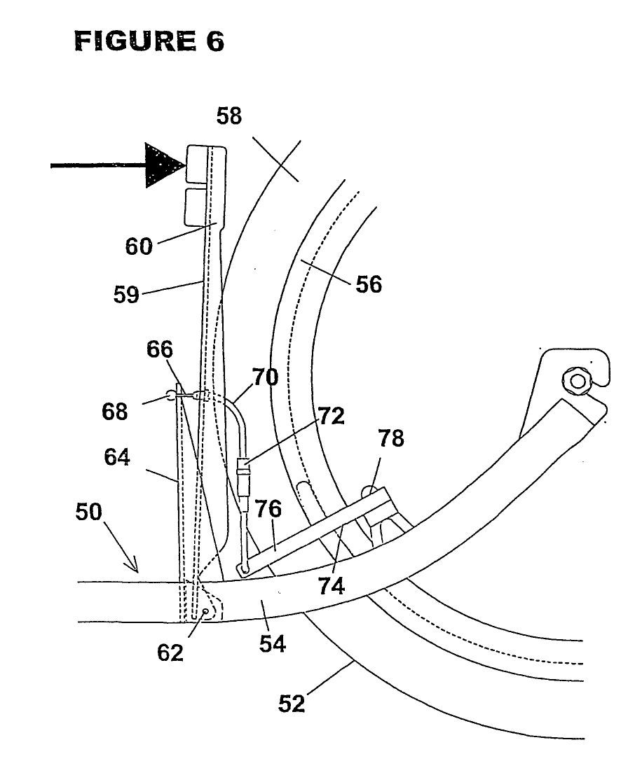

A braking member 60 of the brake means 59 is mounted to the frame 54 by means of a transverse pivotal mounting 62. Further, as can best be seen in FIGS. 5 and 6, an upright plate member 64 is fixedly mounted to the frame 54 just in front of the mounting 62 of the braking member 60.

The plate member 64 has an aperture (not shown) therein through which projects a flexible cable 66. The cable 66 has a nipple 68 mounted at outer end thereof adjacent to the plate member 64. The nipple 68 is larger than the aperture in the plate member 64 so that the outer end of the cable 66 cannot pass through the aperture.

The cable 66 then passes through a conduit 70 which may include a length adjustment means 72.

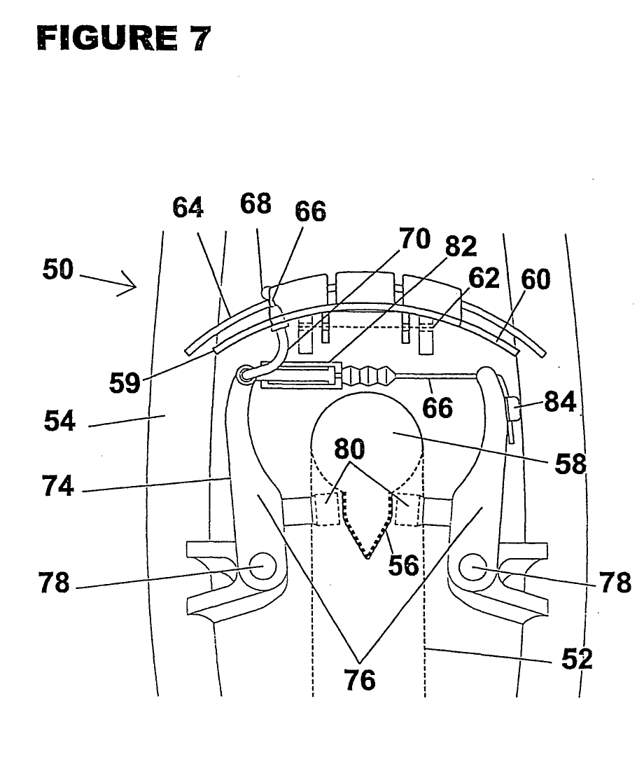

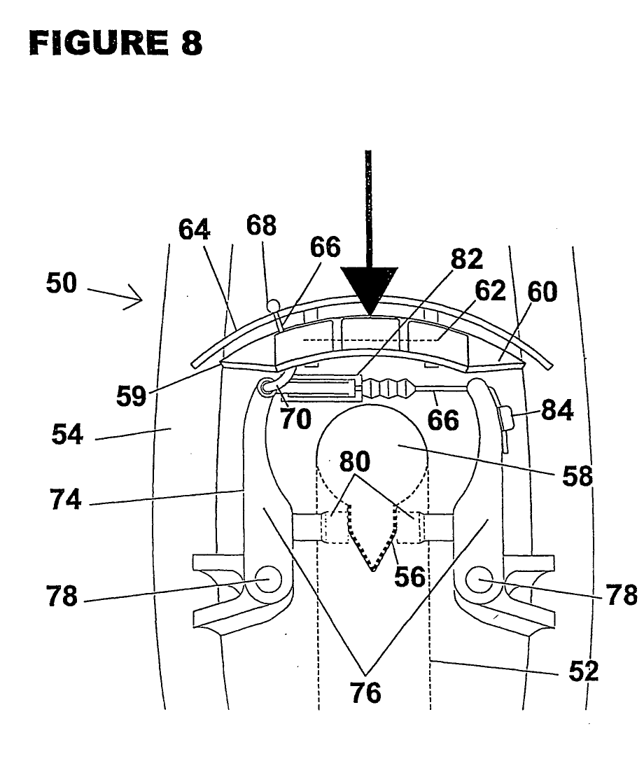

As can be seen in FIGS. 7 and 8, the cable 66 is connected to a bicycle type V-brake 74. The V-brake 74 has a pair of arms 76 pivotally mounted on pivot points 78 and extending forwardly thereof. The conduit 70 is connected to a leading end of a first arm 76 via a swivel cage 82 pivoting off a leading end of one arm 76. The cable 66 exits the conduit 70 at one end of the cage 82 and extends across to a cable clamping screw 84 at a leading end of the other arm 76. Further, forwardly of but adjacent to the pivot points 78 each arm 76 is provided with a brake pad 80.

As can be seen in the drawings, in operation, a rider as shown in FIG. 2, applies pressure to the braking member 60 by means of the calf of a rearwardly disposed leg and pivots the braking member 60 about the pivot 62 so as to move the braking member 60 away from the nipple 68 and therefore shorten the effective length of the cable 66 between the leading ends of the arms 76. This causes these leading ends to be drawn towards each other about the pivot points 78 and therefore causes the brake pads 80 to engage with the rim 56. This action applies braking force to the wheel 52 and therefore slows down the all-terrain vehicle 50 when it is in motion.

Each pair of brake arms 76 incorporates internal spring means for returning the arms 76 to the position shown in FIG. 7 when braking is no longer required and pressure ceases to be applied to the braking member 60.

V Brakes have been used as the example to describe the braking means. However, it is important to note that the principle of a rider leaning against a calf operated lever to activate a cable or hydraulic operated brake also applies to other types of braking mechanisms such as disk brakes and hub brakes.

Modifications and variations such as would be apparent to a skilled addressee are deemed within the scope of the present invention

1. An all-terrain board arranged to be ridden by a rider standing on a board member characterised in that it comprises a wheel means and a brake means having a braking member arranged to be engaged and moved by a leg of a rider so as to apply braking force to the wheel means of the board.

2. An all-terrain board according to claim 1, characterised in that the braking member is arranged to be engaged by a calf of the rider.

3. An all-terrain board according to claims 1 or 2, characterised in that the board has a leading wheel means and a rear wheel means and the braking member is arranged to engage with the rear wheel means.

4. An all-terrain board according to any one of the preceding claims, characterised in that the braking member is arranged to act directly on a wheel of the board.

5. An all-terrain vehicle according to claim 4, characterised in that the braking member is a pivotally mounted upright member which is normally biased away from the wheel but can be pivoted into engagement with the wheel by contact with the leg of the rider.

6. An all-terrain board according to any one of claims 1 to 3, characterised in that the braking member acts indirectly on a wheel of the board.

7. An all-terrain board according to claim 6, characterised in that the braking member acts indirectly on a rim of the wheel of the board.

8. An all-terrain board according to claim 6 or 7, characterised in that the braking member is a pivotally mounted upright member which is normally biased away from the wheel but which can be pivoted into engagement with the wheel by contact with the leg of the rider.

9. An all-terrain board according to claim 8, characterised in that a fixed upright plate is disposed adjacent to but forwardly of the braking member, and a flexible cable means is anchored on the fixed upright plate, the cable means is operationally connected to the braking member so that as the braking member is moved the cable means causes braking force to be applied to the wheel.

10. An all-terrain vehicle according to claim 9, characterised in that the cable is operationally connected to a brake having opposed brake pad members and movable arms, the movable arms being moved by the cable means upon movement of the brake member so that the brake pads engage with the wheel and apply braking force thereto.
